(19) United States
(12) Patent Application Publication
(10) Pub. No.: US 2026/0077459 A1
(43) Pub. Date: Mar. 19, 2026

(54) TORQUE WRENCH

(71) Applicant: TORQUE-TECH PRECISION CO., LTD., TAICHUNG (TW)

(72) Inventor: Tien-Lung LIN, TAICHUNG (TW)

(21) Appl. No.: 19/009,526

(22) Filed: Jan. 3, 2025

(30) Foreign Application Priority Data
Sep. 19, 2024 (TW) 113135586

(51) Int. Cl. B25B 23/142; B25B 23/14

(52) U.S. Cl. CPC B25B 23/1427; B25B 23/141

(57) ABSTRACT

A torque wrench includes a tubular body and a handle rotatably connected to one end of the tubular body. The tubular body has at least one positioning groove. The handle is made of a plastic material and has a reinforcing member made of metal and corresponding to the positioning groove. The reinforcing member has a positioning hole. A positioning member is accommodated in the positioning hole. A control bushing is slidably sleeved onto the handle. The control bushing can press and force the positioning member to partially extend out of the positioning hole and to be engaged in the positioning groove. In light of this, the torque wrench can effectively avoid damage caused by a user's operation error.

### FIELD OF THE INVENTION

The present invention relates to a torque wrench, and more particularly to a lightweight torque wrench with a plastic handle.

### BACKGROUND OF THE INVENTION

A conventional torque wrench has a tubular body, a ratchet head mounted at one end of the tubular body, and a trip unit mounted inside the tubular body. The trip unit is pushed by a spring and elastically pressed against the ratchet head. When the force applied to the ratchet head reaches a preset torque value, the trip unit will trip and alert the user to stop operation. In addition, a handle is rotatably connected to the other end of the tubular body. An adjustment unit is disposed inside the handle. The adjustment unit is configured for adjusting the elastic force of the spring along with rotation of the handle to change the preset torque value.

As shown in FIG. 21, the handle 1 has a perforation 2. A locking member 3 is accommodated in the perforation 2 for locking the position of the handle 1 to prevent the handle 1 from unexpected rotation. However, for reduction of the weight of the torque wrench, the handle 1 is usually made of a plastic material. When the user rotates the handle 1 without releasing the locking member 3 due to an operation error, the perforation 2 is deformed, cracked or even crushed, as shown in FIG. 21, so that the service life of the conventional torque wrench is shortened.

### SUMMARY OF THE INVENTION

The primary object of the present invention is to provide a torque wrench which can effectively prevent damage caused by the user's operation error to have a fool-proof effect.

In order to achieve the foregoing object, the torque wrench provided by the present invention comprises a tubular body, a ratchet head, a trip unit, an elastic member, a handle, and a locking unit. The tubular body has a first end and a second end opposite to the first end. The ratchet head is connected to the first end. The ratchet head has a force-receiving portion. The trip unit is disposed inside the tubular body. The trip unit is connected to the elastic member. The elastic member elastically pushes the trip unit against the force-receiving portion. The elastic member is connected to an adjustment unit configured for adjusting an elastic force of the elastic member. The handle is rotatably connected to the second end. The locking unit is connected to the handle for locking a position of the handle. A positioning groove is formed on an external periphery of the second end of the tubular body. The handle is made of a plastic material and has a positioning portion corresponding to the positioning groove. The positioning portion has a reinforcing member. The reinforcing member is made of metal and has a positioning hole. The positioning hole communicates with the positioning groove. The locking unit includes a positioning member accommodated in the positioning hole and a control bushing sleeved onto the handle. The control sleeve has a pressing portion formed at an inner side thereof. The control bushing is slidable along an axial direction of the handle. The pressing portion is selectively aligned with the positioning hole for pressing and forcing the positioning member to partially extend out of the positioning hole and to be engaged in the positioning groove.

In the torque wrench provided by the present invention, when the user rotates the handle by force due to an operational error when the positioning member is still engaged in the positioning groove, the reinforcing member can effectively resist a lateral force transmitted from the positioning member since it is made of metal and has high rigidity, so that the positioning hole will be not damaged. Therefore, the torque wrench is lightweight, preferably durable, and effectively prevents damage caused by the user's operation error to render a fool-proof effect.

### BRIEF DESCRIPTION OF THE DRAWINGS

FIG. 1 is a perspective view of a torque wrench in accordance with a first embodiment of the present invention;

FIG. 2 is a cross-sectional view of the torque wrench in accordance with the first embodiment of the present invention;

FIG. 3 is a partially exploded view of the torque wrench, illustrating a locking unit in accordance with the first embodiment of the present invention;

FIG. 4 is a partially cross-sectional view of the torque wrench in accordance with the first embodiment of the present invention, illustrating that a control bushing is located at a locked position;

FIG. 5 is a partially cross-sectional view of the torque wrench in accordance with the first embodiment of the present invention, illustrating that the control bushing is located at a released position;

FIG. 6 is a sectional view taken along a line 6-6 indicated in FIG. 4;

FIG. 7 is a partially exploded view of the torque wrench, illustrating a reinforcing member in accordance with the first embodiment of the present invention;

FIG. 8 is a schematic view of insert molding for the present invention;

FIG. 9 is a partially exploded view of the torque wrench, illustrating an adjustment unit in accordance with the first embodiment of the present invention;

FIG. 10 is a partially enlarged cross-sectional view of the torque wrench, illustrating a handle in accordance with the first embodiment of the present invention;

FIG. 11 is a perspective view of a driving member in accordance with the first embodiment of the present invention;

FIG. 12 is a sectional view taken along a line 12-12 indicated in FIG. 10;

FIG. 13 is a partially exploded view of a torque wrench, illustrating a reinforcing member in accordance with a second embodiment of the present invention;

FIG. 14 is a sectional view of a part of the torque wrench, illustrating the reinforcing member in accordance with the second embodiment of the present invention;

FIG. 15 is a partially exploded view of the torque wrench, illustrating a reinforcing member in accordance with a third embodiment of the present invention;

FIG. 16 is a sectional view of a part of the torque wrench, illustrating the reinforcing member in accordance with the third embodiment of the present invention;

FIG. 17 is a partially exploded view of the torque wrench, illustrating a reinforcing member in accordance with a fourth embodiment of the present invention;

FIG. 18 is a sectional view of a part of the torque wrench, illustrating the reinforcing member in accordance with the fourth embodiment of the present invention;

FIG. 19 is a partially exploded view of the torque wrench, illustrating a reinforcing member in accordance with a fifth embodiment of the present invention;

FIG. 20 is a sectional view of a part of the torque wrench, illustrating the reinforcing member in accordance with the fifth embodiment of the present invention; and

FIG. 21 is a schematic view of a handle of a conventional torque wrench.

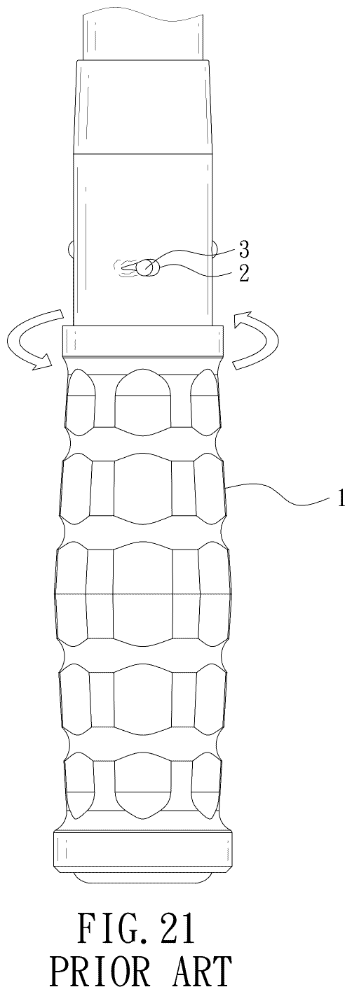

### DETAILED DESCRIPTION OF THE PREFERRED EMBODIMENTS

Embodiments of the present invention will now be described, by way of examples only, with reference to the accompanying drawings.

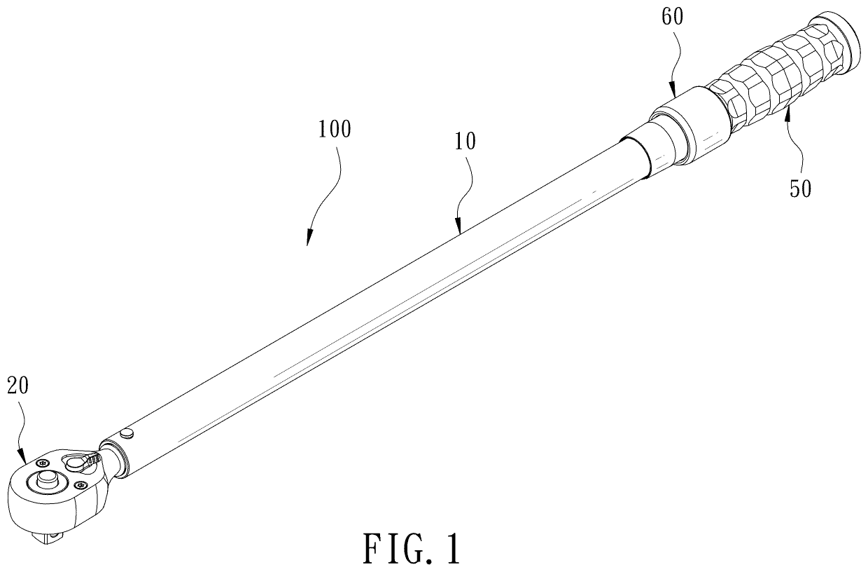

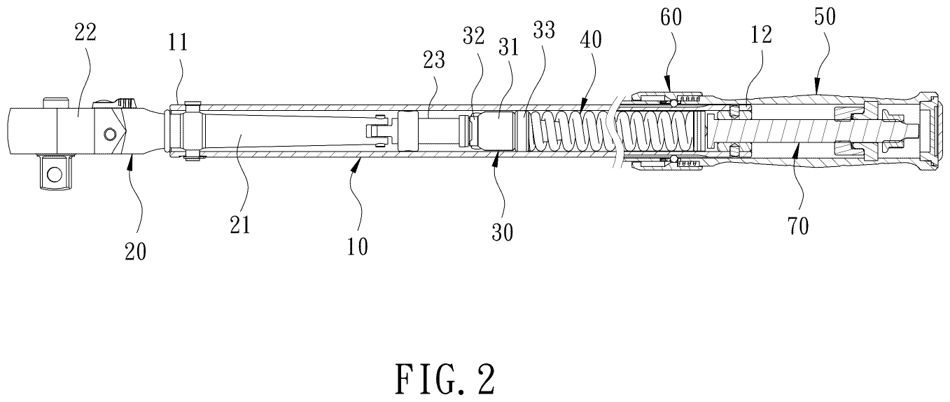

As shown in FIG. 1 and FIG. 2, a torque wrench 100 constructed in accordance with a first embodiment of the present invention comprises a tubular body 10, a ratchet head 20, a trip unit 30, an elastic member 40, a handle 50, a locking unit 60, and an adjustment unit 70. The tubular body 10 is made of metal and has a first end 11 and a second end 12 opposite to the first end 11. The ratchet head 20 is connected to the first end 11. The ratchet head 20 has a rod body 21. The rod body 21 has two ends, one of which extends out of the tubular body 10 and has a head portion 22 and the other is inserted into the first end 11 and provided with a force-receiving portion 23. The trip unit 30 is disposed inside the tubular body 10 and close to the force-receiving portion 23. The elastic member 40 is disposed at the other end of the trip unit 30 and opposite to the force-receiving portion 23. The elastic member 40 elastically pushes the trip unit 30 against the force-receiving portion 23, so that the trip unit 30 has a preset torque value. The trip unit 30 generally includes a holding member 31 and a roller 32 located between the holding member 31 and the force-receiving portion 23. Preferably, a spring seat 33 is provided between the holding member 31 and the elastic member 40. The operation and principle of the trip unit 30 belong to prior art, so they will not be recited further hereinafter. The handle 50 is rotatably connected to the second end 12 of the tubular body 10. The locking unit 60 is disposed onto the handle 50 for locking the handle 50 in position. The adjustment unit 70 is disposed inside the handle 50. The adjustment unit 70 is configured for adjusting the elastic force of the elastic member 40 to change the preset torque value.

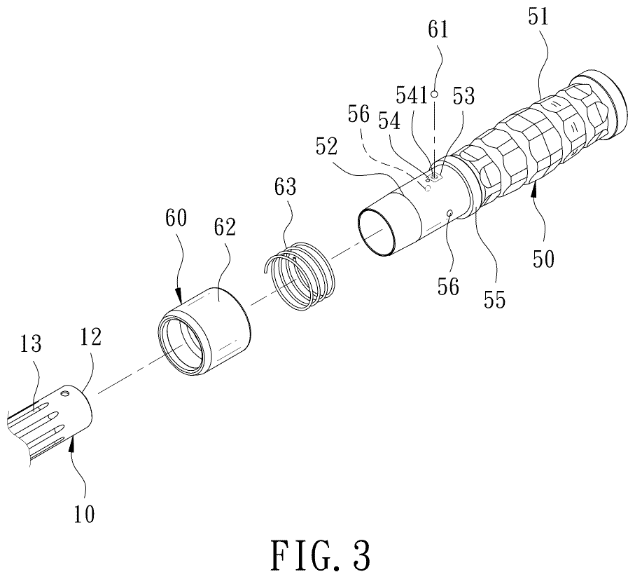

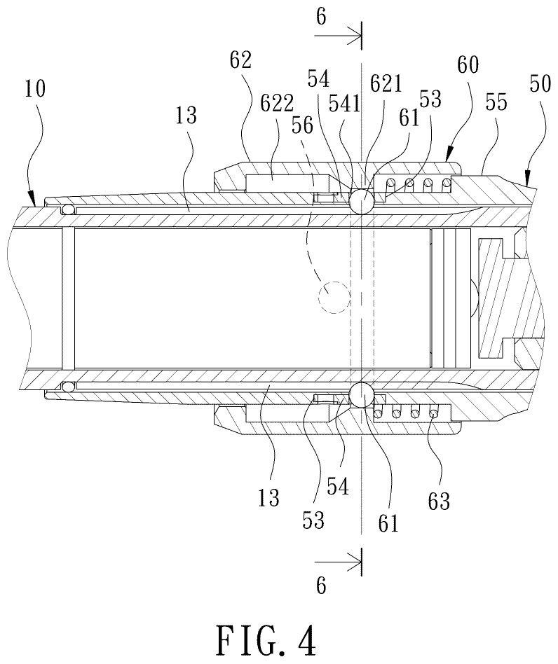

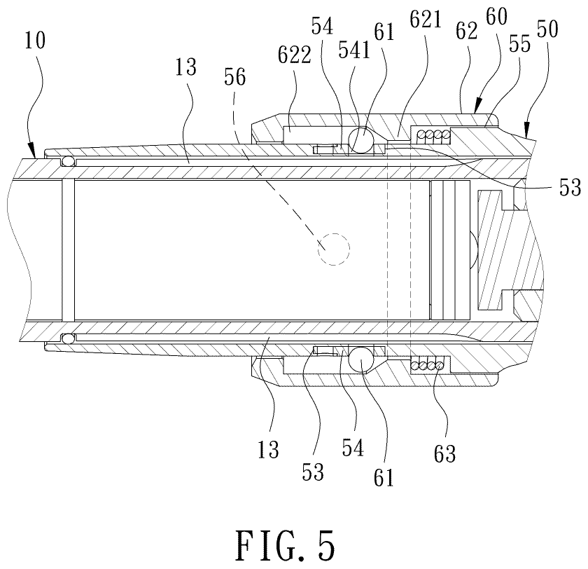

As shown in FIG. 3 and FIG. 4, the handle 50 is made of a plastic material and is structurally hollow, so that the handle 50 is rotatably sleeved onto the second end 12 of the tubular body 10. The handle 50 has a gripping section 51 for the user to grip the handle 10 with his/her hand and a mounting section 52 for mounting the locking unit 60. At least one positioning groove 13 is formed on the external periphery of the second end 12 of the tubular body 10. The mounting section 52 has at least one positioning portion 53 formed in the tubular wall of the handle 50 and corresponding to the positioning groove 13. At least one reinforcing member 54 is disposed on the positioning portion 53. The reinforcing member 54 is made of metal and has at least one positioning hole 541 communicating with the positioning groove 13. The locking unit 60 has at least one positioning member 61 accommodated in the positioning hole 541 and a control bushing 62 slidably sleeved onto the mounting section 52. The control bushing 62 has an annular pressing portion 621 and an annular shrinkage groove 622 at an inner side thereof. In this embodiment, a plurality of positioning grooves 13 are formed on the second end 12 and arranged annularly at intervals. The handle 50 includes two positioning portions 53 and two reinforcing members 54. The locking unit 60 has two positioning members 61. The positioning members 61 are steel balls and accommodated in the respective positioning holes 541. The control bushing 62 is slidable along the mounting section 52 between a locked position and a released position. When the control bushing 62 is located at the locked position, as shown in FIG. 4, the pressing portion 621 is selectively aligned with the positioning holes 541 to confine the positioning members 61 in the respective positioning holes 541, and the positioning members 61 partially extend out of the respective positioning holes 541 to be engaged in the respective positioning grooves 13. At this moment in time, the handle 50 is locked in position and cannot be freely rotated relative to the tubular body 10. When the control bushing 62 is located at the released position, as shown in FIG. 5, the shrinkage groove 622 is selectively aligned with the positioning holes 541 for the positioning members 61 to slide to the shrinkage groove 622 from the respective positioning holes 541; at this moment in time, the handle 50 is unlocked and can be freely rotated relative to the tubular body 10. Preferably, the handle 50 further includes a stop portion 55 between the gripping section 51 and the mounting section 52. The locking unit 60 further has a spring 63. The spring 63 is located between the stop portion 55 and the pressing portion 621. At least one restricting portion 56 protrudes from the external periphery of the mounting section 52. The restricting portion 56 is located opposite to the pressing portion 621. In this way, the sliding stroke of the control bushing 62 is limited between the restricting portion 56 and the stop portion 55, and the control bushing 62 keeps being pushed by the elastic force of the spring 63 to be held at the locked position. In this embodiment, there are two restricting portions 56.

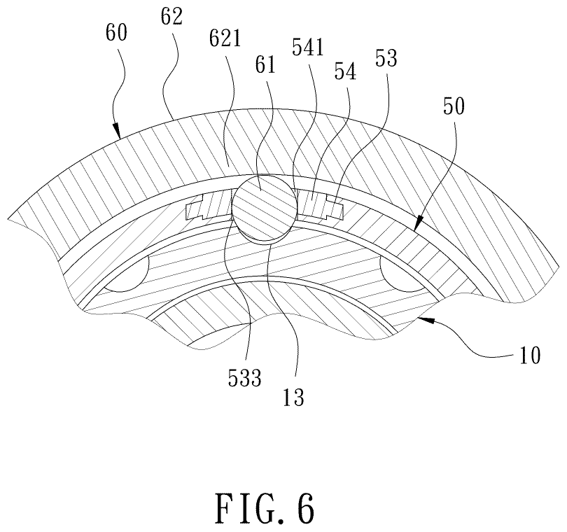

Referring to FIG. 6, when the control bushing 62 is located at the locked position or before the control bushing 62 is moved to the released position, the user rotates the handle 50 to adjust the torque by force due to an operational error; or when the user rotates a fastener and the preset torque value has been reached, he/she continues to rotate the fastener by force. At this moment in time, since the reinforcing members 54 are made of metal and have high rigidity, they can effectively resist the lateral force transmitted from the positioning members 61 to secure the positioning holes 541 from damage. In addition, during the long-term use of the torque wrench 100, the reinforcing members 54 can withstand the long-term friction with the positioning members 61 so that the positioning holes 541 will not be deformed. In this way, the torque wrench 100 of the present invention is lightweight, preferably durable, and effectively prevents damage caused by the user's operation error to render a fool-proof effect.

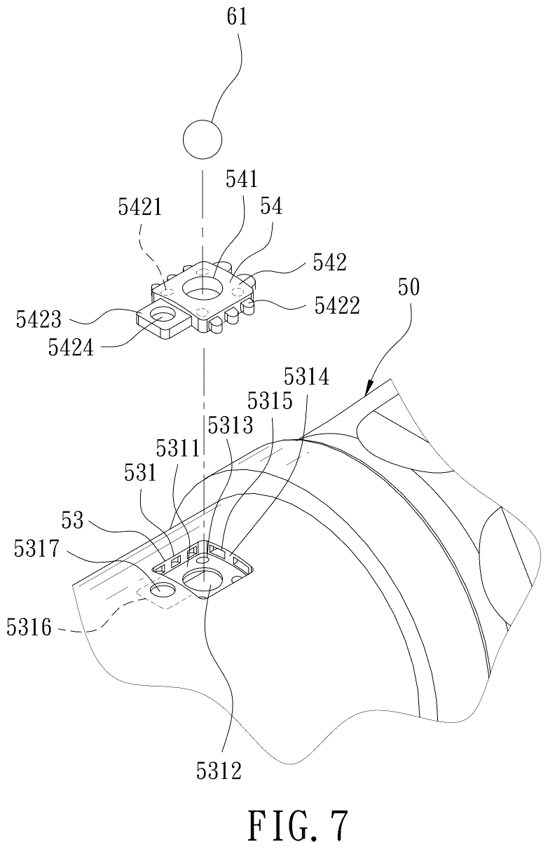

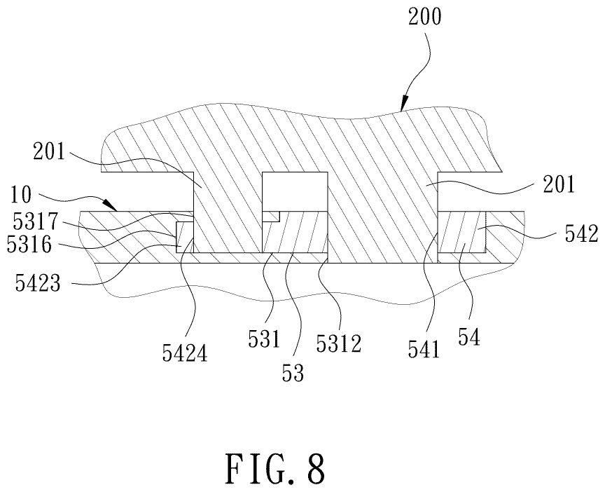

Referring to FIG. 7, each of the positioning portions 53 has a first accommodating space 531 and a bottom wall 5311 formed in the first accommodating space 531. A first communication hole 5312 runs through the bottom wall 5311. Each of the reinforcing member 54 has a first plate 542 accommodated in the first accommodating space 531. The first plate 542 has the positioning hole 541 running therethrough. The positioning hole 541 communicates with the positioning groove 13 via the first communication hole 5312, as shown in FIG. 6. The bottom wall 5311 has a plurality of indentations 5313. The first plate 542 has a plurality of protrusions 5421 formed at an underside thereof and corresponding to the indentations 5313, respectively. The protrusions 5421 are accommodated in the corresponding indentations 5313. In addition, each of the positioning portion 53 further has an annular wall 5314 surrounding the bottom wall 5311. A plurality of recesses 5315 are arranged at intervals. A plurality of protruding portions 5422 are formed on peripheral sides of the first plate 542 and accommodated in the recesses 5315 corresponding thereto, respectively, so that the bonding strength between the reinforcing member 54 and the handle 50 can be greatly enhanced. Preferably, the reinforcing member 54 is integrally formed with the positioning portion 53 by insert molding, so as to achieve a preferable bonding effect. Preferably, the first plate 542 further includes an extension portion 5423 protruding from one of the peripheral sides thereof and an auxiliary positioning hole 5424 running through the extension portion 5423. In the process of the insert molding, as shown in FIG. 8, two positioning columns 201 of a positioning mechanism of an injection mold 200 are inserted into the positioning hole 541 and the auxiliary positioning hole 5424, respectively. After the insertion molding is completed, an extension groove 5316 running through the annular wall 5314 is formed inside the tubular wall of the handle 50 and the extension portion 5423 is encapsulated inside the extension groove 5316. When the positioning mechanism of the injection mold 200 is removed, an extension hole 5317 running through the periphery of the handle 50 and adjacent to extension groove 5316 is formed. In this way, the injected plastic is filled in the auxiliary positioning hole 5424 to form a snap-fit structure (not shown), so that the bonding effect between the reinforcing member 54 and the handle 50 can be further enhanced. Alternatively, the reinforcing member 54 and the positioning portion 53 can be formed in one piece by thermosetting, ultrasonic welding, or other feasible means.

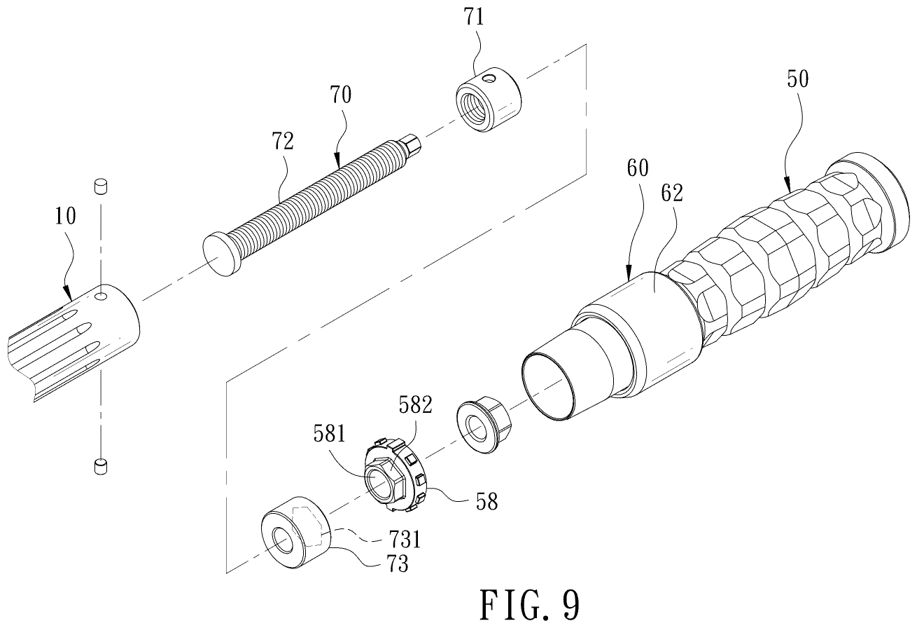

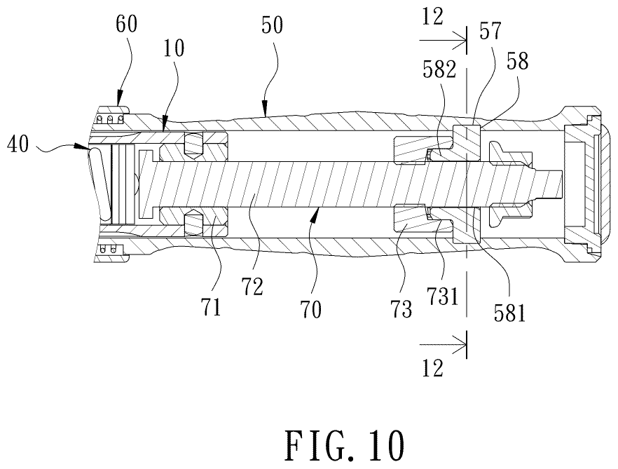

As shown in FIG. 9 and FIG. 10, the adjustment unit 70 includes a screw nut 71 located inside the tubular body 10 and a screw rod 72 screwed to the screw nut 71. The screw rod 72 has two ends, one of which contacts against the elastic member 40 and the other extends toward the handle 50 and has a driven member 73. The driven member 73 has a polygonal groove 731. The handle 50 has a fixing portion 57. A driving member 58 is fixed to the fixing portion 57. The driving member 58 is made of metal and has a through hole 581 for the screw rod 72 to pass through. The driving member 58 has a polygonal projecting portion 582 surrounding the through hole 581. The polygonal projecting portion 582 is inserted into the polygonal groove 731. When the control bushing 62 is located at the released position, the user can rotate the handle 50 to drive the driving member 58 to rotate synchronously, and the driving member 58 drives the driven member 73 via the polygonal projecting portion 582, thereby driving the screw rod 72 to screw forward and backward along the axial direction of the handle 50 to adjust the elastic force of the elastic member 40, so as to change the preset torque value. Since the driving member 58 is made of metal and has high rigidity, during the long-term use of the torque wrench 100, the polygonal projecting portion 582 can withstand long-term friction without excessive wear and tear, thus ensuring that the driving member 58 drives the driven member 73 stably.

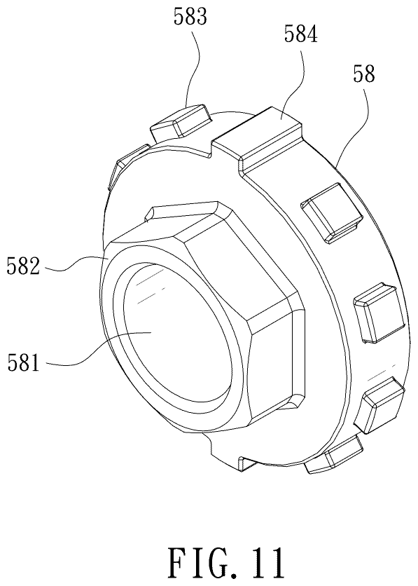

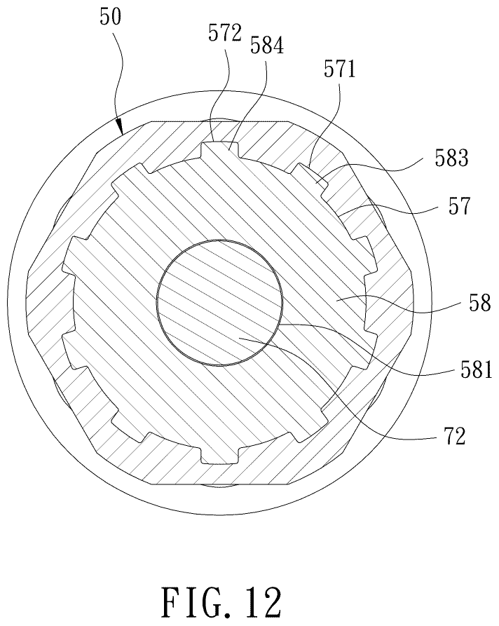

As shown in FIG. 11 and FIG. 12, the fixing portion 57 has a plurality of fixing grooves 571. A plurality of fixing blocks 583 protrude from an external periphery of the driving member 58, corresponding to the fixing grooves 571. The fixing blocks 583 are accommodated in the corresponding fixing grooves 571, respectively. Thus, the driving member 58 is coupled to the fixing portion 57 stably. Preferably, the driving member 58 is integrally formed with the fixing portion 57 by insert molding, so as to achieve a preferable bonding effect. Furthermore, the handle 50 has at least one alignment groove 572. The periphery of the driving member 58 has at least one alignment block 584 corresponding to one corner of the polygonal projecting portion 582. The alignment block 584 is accommodated in the alignment groove 572. In this embodiment, the polygonal projecting portion 582 has a hexagonal shape, the handle 50 has two alignment grooves 572, and the periphery of the driving member 58 has two alignment blocks 584. The alignment blocks 584 correspond to a pair of diagonal corners of the polygonal projecting portion 582. In this way, the driving member 58 can be accurately positioned to the fixing portion 57 in the process of the insert molding. Alternatively, the driving member 58 and the fixing portion 57 can be formed in one piece by thermosetting, ultrasonic welding, or other feasible means.

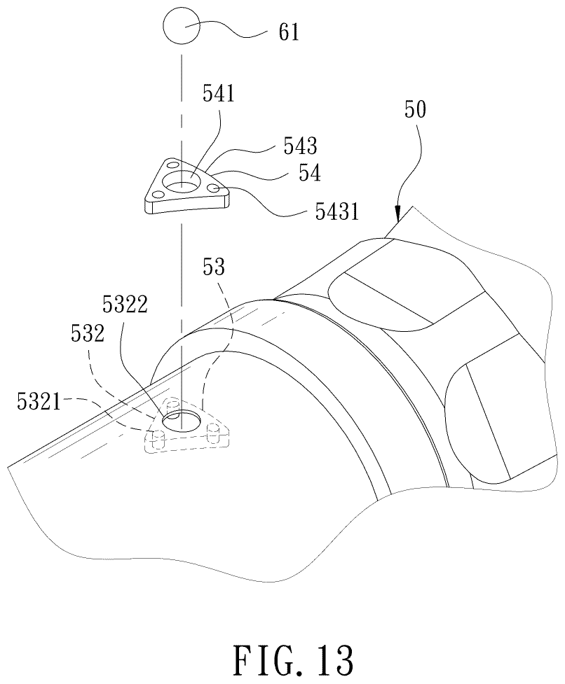

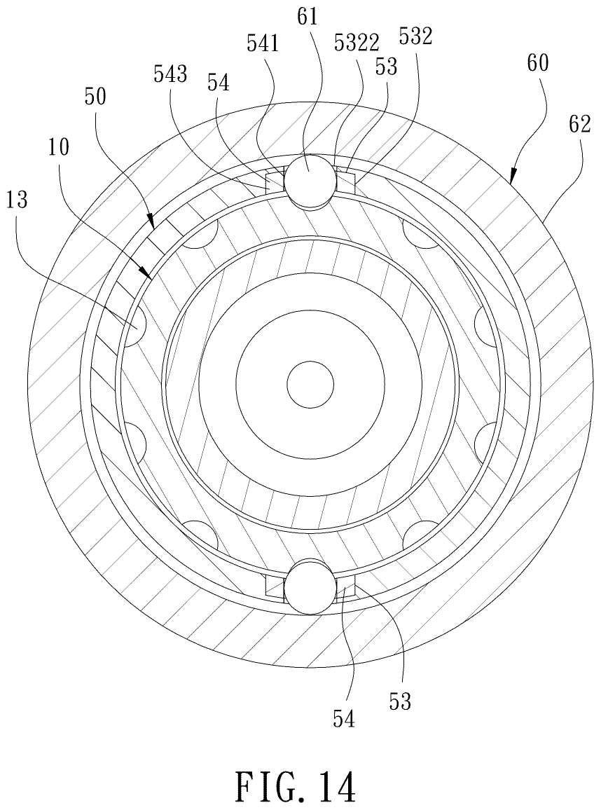

It is worth mentioning that the reinforcing member 54 and the positioning portion 53, as set forth above, can be formed in one piece by the insert molding and variously embodied as follows. FIG. 13 and FIG. 14 illustrate a second embodiment of the present invention. The handle 50 has two positioning portions 53 and two reinforcing members 54. Each of the reinforcing members 54 has a second plate 543 and each of the second plate 543 has the positioning hole 541 and a plurality of through holes 5431 surrounding the positioning hole 541. Each of the positioning portions 53 has a second accommodating space 532 located in the tubular wall of the handle 50 and corresponding to the second plate 543. A plurality of fixing posts 5321 are formed in each of the second accommodating space 532 and correspond to the through holes 5431, respectively. Each of the positioning portion 53 further has a second communication hole 5322 running therethrough and corresponding to the positioning hole 541. Each of the second plate 543 has a polygonal shape and corresponds in shape to the second accommodating space 532. Preferably, the second plate 543 and the second accommodating space 532 are, but not limited to, triangular or polygonal in shape as shown in the second embodiment.

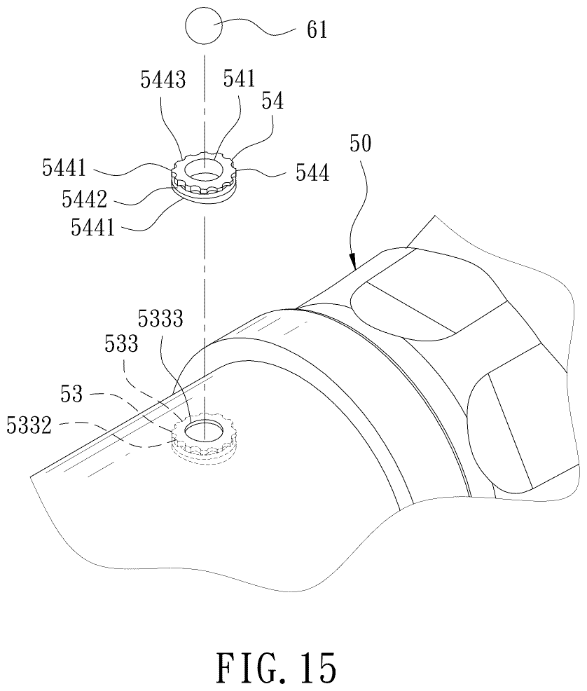

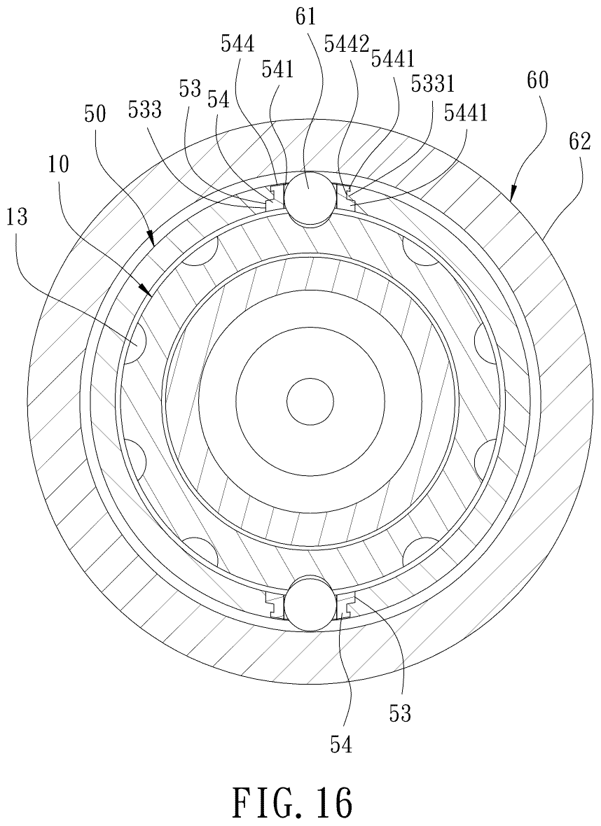

FIG. 15 and FIG. 16 illustrate a third embodiment of the present invention. The handle 50 has two positioning portions 53 and two reinforcing members 54. Each of the reinforcing member 54 has a third plate 544. Each of the third plate 544 has the positioning hole 541, a plurality of protruding rings 5441 surrounding the periphery of the third plate 544, and an annular groove 5442 spacing the protruding rings 5441 from each other. At least one of the protruding rings 5441 has a plurality of toothed grooves 5443 formed at intervals on the periphery thereof. Each of the positioning portion 53 has a third accommodating space 533 located in the tubular wall of the handle 50 and corresponding to the third plate 544. An annular rib 5331 is formed in each of the third accommodating spaces 533 and corresponds to the annular groove 5442. A plurality of toothed portions 5332 are formed in each of the third accommodating spaces 533 and correspond to the toothed grooves 5443. Each of the positioning portions 53 has a third communication hole 5333 and corresponds to the positioning hole 541. Each of the third plates 544 has, but not limited to, a circular shape corresponding to that of the third accommodating space 533. They may be trigonal or polygonal in shape.

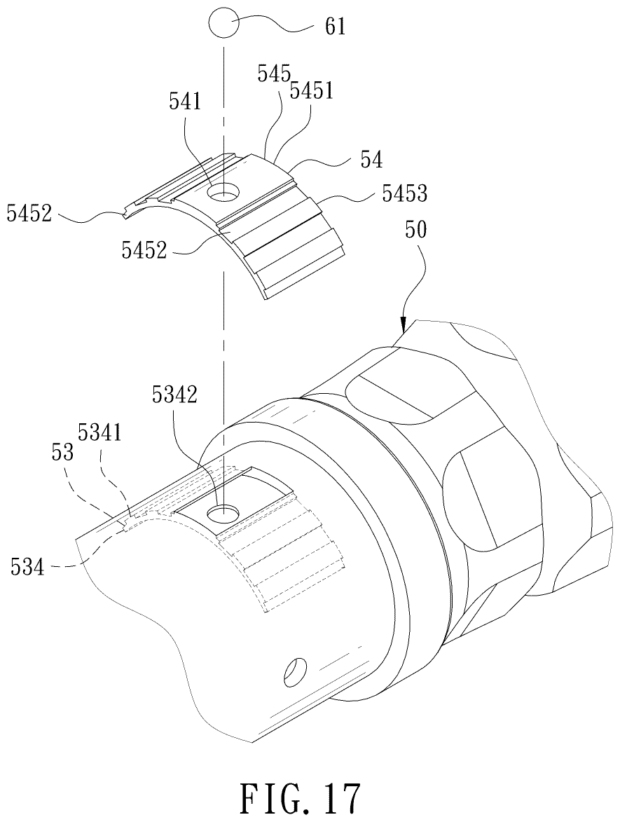

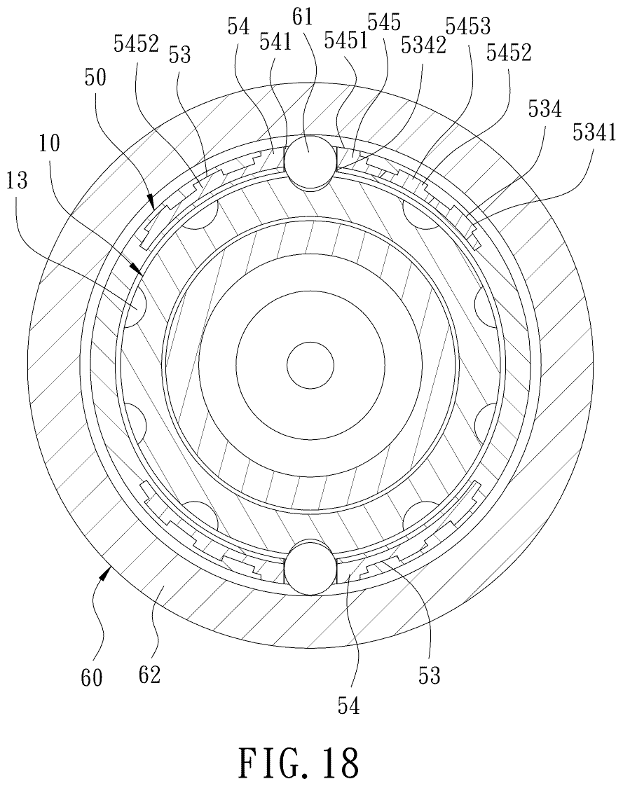

FIG. 17 and FIG. 18 illustrate a fourth embodiment of the present invention. The handle 50 has two positioning portions 53 and two reinforcing members 54. Each of the reinforcing members 54 has a fourth plate 545. Each of the fourth plate 545 has a first mounting portion 5451. Each of the first mounting portions 5451 has the positioning hole 541. A pair of wing portions 5452 extend from two sides of the first mounting portion 5451, respectively. A plurality of first elongated ribs 5453 are formed on an external surface of the wing portions 5452 and arranged at intervals. Each of the positioning portions 53 has a fourth accommodating space 534 located in the tubular wall of the handle 50 and corresponding to the fourth plate 545. A plurality of first elongated grooves 5341 are formed in each of the fourth accommodating spaces 534 and correspond to the first elongated ribs 5453, respectively. Each of the positioning portions 53 further has a fourth communication hole 5342 corresponding to the positioning hole 541. Each of the fourth plates 545 is arc-shaped and corresponds in shape to the fourth accommodating space 534.

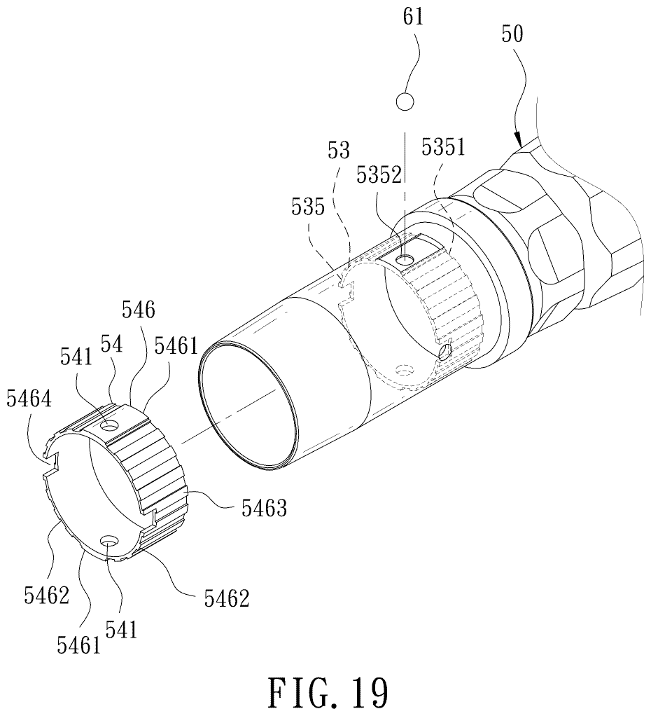

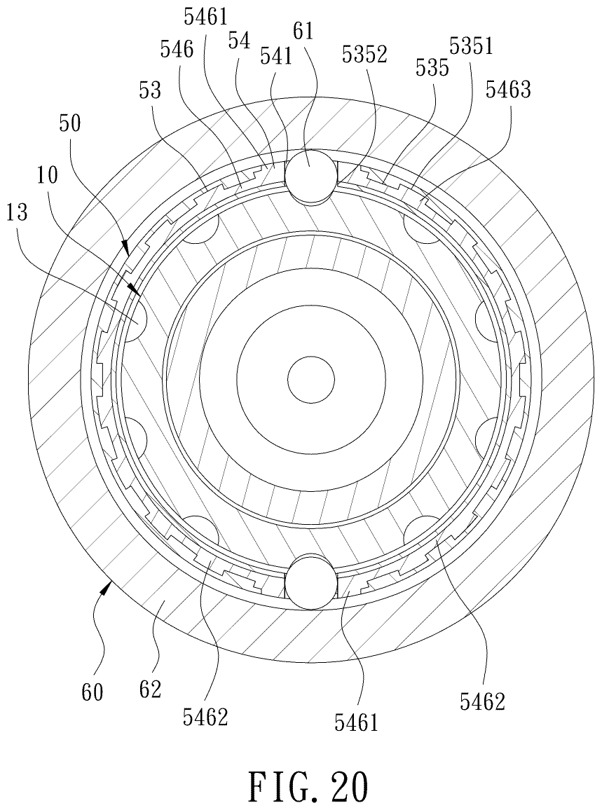

FIG. 19 and FIG. 20 illustrate a fifth embodiment of the present invention. The reinforcing member 54 has an annular body 546. The annular body 546 has a plurality of second mounting portions 5461. The second mounting portions 5461 each have the positioning hole 541. A connecting portion 5462 is connected between every two adjacent ones of the second mounting portions 5461. A plurality of second elongated ribs 5463 are formed on an external surface of the connecting portion 5462 and arranged at intervals. The annual body 546 has at least one first notch 5464 corresponding to the restricting portion 56. The positioning portion 53 has a fifth accommodating space 535 located in the tubular wall of the handle 50 and corresponding to the annular body 546. A plurality of second elongated grooves 5351 are formed in the fifth accommodating space 535 and correspond to the second elongated ribs 5463, respectively. The positioning portion 53 has at least one fifth communication hole 5352 corresponding to the positioning hole 541.

What is claimed is:

1. A torque wrench comprising:
a tubular body having a first end and a second end opposite to the first end, at least one positioning groove being formed on a periphery of the second end;
a ratchet head connected to the first end and having a force-receiving portion;
a trip unit being located inside the tubular body;
an elastic member connected to the trip unit for elastically pushing the trip unit against the force-receiving portion;
an adjustment unit connected to the elastic member and configured for adjusting an elastic force of the elastic member;
a handle made of a plastic material, rotatably connected to the second end, and having at least one positioning portion corresponding to the at least one positioning groove;
at least one reinforcing member made of metal, located at the at least one positioning portion, and having at least one positioning hole, the at least one positioning hole communicating with the at least one positioning groove; and
a locking unit made of a plastic material, connected to the handle for locking a position of the handle, and having at least one positioning portion, at least one positioning member, and a control sleeve, the at least one positioning portion corresponding to the positioning groove, the at least one positioning member being accommodated in the at least one positioning hole, the control bushing being sleeved onto the handle and having a pressing portion formed at an inner side thereof, the control bushing being slidable along an axial direction of the handle, the pressing portion being selectively aligned with the positioning hole for forcing the positioning member to partially extend out of the positioning hole and to be engaged in the positioning groove.

2. The torque wrench as claimed in claim 1, wherein the positioning portion comprises a first accommodating space, a bottom wall and an annular wall being formed in the first accommodating space, a first communication hole running through the bottom wall, the first communication hole communicating with the positioning groove, the reinforcing member having a first plate accommodated in the first accommodating space, the first plate having the positioning hole, the positioning hole communicating with the first communication hole.

3. The torque wrench as claimed in claim 2, wherein the bottom wall comprises a plurality of indentations, and the first plate comprises a plurality of protrusions formed at an underside thereof and corresponding to the indentations, the protrusions being accommodated in the corresponding indentations, respectively.

4. The torque wrench as claimed in claim 2, wherein the annular wall comprises a plurality of recesses, the first plate comprises a plurality of protruding portions formed on a periphery thereof and corresponding to the recesses, the protruding portions being accommodated in the corresponding recesses, respectively.

5. The torque wrench as claimed in claim 2, wherein the annular wall comprises an extension groove, and the first plate comprises an extension portion extending from a periphery thereof, the extension portion being accommodated in the extension groove and having an auxiliary positioning hole running therethrough.

6. The torque wrench as claimed in claim 1, wherein the reinforcing member is integrally formed with the handle by either of insert molding, thermosetting, and ultrasonic welding.

7. The torque wrench as claimed in claim 1, wherein the adjustment unit comprises a screw nut mounted inside the tubular body and a screw rod screwed with the screw nut, one end of the screw rod contacting against the elastic member, the screw rod extending toward the handle from the other end of the screw rod, the driven member having a polygonal groove, the handle having a fixing portion, a driving member bring fixed to the fixing portion, the driving member being made of metal and having a polygonal projecting portion, the polygonal projecting portion is inserted into the polygonal groove.

8. The torque wrench as claimed in claim 7, wherein the fixing portion comprises a plurality of fixing grooves, and the driving member comprises a plurality of fixing blocks protruding from a periphery thereof and corresponding to the fixing grooves, the fixing blocks being accommodated in the corresponding fixing grooves, respectively.

9. The torque wrench as claimed in claim 7, wherein the handle comprises at least one alignment groove, and the driving member comprises at least one alignment block corresponding to a corner of the polygonal projecting portion, the alignment block being accommodated in the alignment groove.

10. The torque wrench as claimed in claim 7, wherein the driving member is integrally formed with the handle by either of insert molding, thermosetting, and ultrasonic welding.
